(19) United States
(12) Patent Application Publication
(10) Pub. No.: US 2002/0023004 A1
(43) Pub. Date: Feb. 21, 2002

(54) Online store management system

(76) Inventors: Richard Hollander, Fort Worth, TX (US); John Kenny, Grapevine, TX (US)

Correspondence Address: ANDREW F. BODENDORF, Fish & Richardson P.C., 601 Thirteenth Street, NW, Washington, DC, 20005, US

(21) Appl. No.: 09/885,915

(22) Filed: Jun. 22, 2001

Related U.S. Application Data
(60) Provisional application No. 60/213,794, filed on Jun. 23, 2000.

(51) Int. Cl. G06G 1/14; G06F 17/60

(52) U.S. Cl. 705/22

(57) ABSTRACT

An online POS store management system permits a home office to supervise a number of stores. The home office and stores are connected by a virtual private network. Each store has a number of processing devices that provide user interfaces for store personnel. Each processing device includes communications software to exchange data with the home office.

This application claims benefit of U.S. Provisional Application No. 60/213,749, filed Jun. 23, 2000, the entire disclosure of which is incorporated herein by reference.

### TECHNICAL FIELD

This invention relates to an online store management method and system for use, for example, in managing multiple stores from a single home office.

### BACKGROUND

Many stores use computers to help manage daily operations efficiently. According to a conventional point-of-sale (POS) store management system, a store is provided with one or more POS computers. The POS computers are typically located at sales stations. However, POS computers may also be located in other areas, such as customer service stations.

A POS computer processes a transaction between a customer and a sales representative. The POS computer includes a graphical user interface (GUI) allowing a user to display product information. In addition, the POS computer calculates prices, manipulates customer information, processes orders, accesses inventory, processes transactions, and stores data.

Other computers may be located at the store to facilitate other activities, such as accounting, payroll, and inventory. A primary computer can also be located at the store to run POS management software. The primary computer may be networked to each of the store computers to service requests for processing and to manage store operations. The primary computer also maintains a database. The database can store data regarding pricing, inventory, purchase orders, customer and employee information, transactions from the POS computers, and other data used for the store's daily operations. In addition, the database can be accessed by the store computers and their associated memories.

In a multi-store company, a POS management system may be located at each store. Each store's primary computer may be connected through a communication line with the other stores' primary computers to form a wide area network (WAN). A modem connected to a store's primary computer is used to contact a modem at another store to exchange information between stores. However, the WAN configuration described above has high connectivity charges and processing demands because each store must constantly update the database in every other store to maintain accurate data for each store. On the other hand, if each store only connects intermittently, for example, at the end of the business day, connectivity charges may be reduced at the cost of having the information contained in each store's database not being up-to-date and accurate during the business day.

### SUMMARY

In one general aspect, the invention provides an online POS store management system. Embodiments may include one or more of the following features. For example, a home office may supervise a number of stores connected by a virtual private network, such as a virtual private tunnel over the Internet. Each store has a number of processing devices that provide user interfaces for store personnel. Each processing device includes communications software to exchange data with the home office. For example, the processing devices may be personal computers running browser software. The browser software allows the personal computers to communicate with application servers in the home office.

Store employees may access forms using the processing device. The forms are interactive multimedia documents that aid store personnel in conducting tasks, including POS activities. The forms display transaction data requested by a store employee. The forms also solicit information needed to activate or complete a transaction. In addition, the forms have standardized responses and self-checking features to ensure accurate data management and processing.

Data solicited by the forms are entered by an employee and are packetized by the browser. A router encapsulates, encrypts, and applies authentication information to the browser packets. The packets are sent through the virtual private tunnel using a point-to-point protocol. The packets are received at the home office and routed to one of the application servers. Data corresponding to entries in the forms are used by the application servers as input for the management software running on the application servers. The management software implements applications that are used to conduct store business.

A database, located at the home office, stores data used by the application servers to manage the stores. Each store accesses the database through the application servers at the home office.

The online POS store management system can be used to manage any number of different types of stores. For example, the online store management system can manage a rent-to-own store. According to a tire rental process, a store employee captures a digital image of a customer's car. A search based on the type of car is performed using the database at the home office to locate items that can be installed on the customer's car. The car can be displayed with, for example, merchandise corresponding to the result of the search. The customer can select any of the displayed merchandise that are desired for rental. A quote is presented for any merchandise selected by the customer. In addition, the sales employee may adjust the quote to find a payment method that is acceptable to the customer.

After the customer has approved the payment method, the customer's application is submitted for approval. If approved, the customer's quote is converted to a work order and the items are installed on the customer's car. In addition, a final rental agreement is generated from the customer information.

The online POS store management system may provide one or more of the following advantages. First, since all forms displayed by the processing devices are standardized, training employees to use the POS system is simplified. In addition, once trained, an employee can operate the POS system at any store without additional training. Furthermore, since the forms are self-checking and have limited, standardized data entries, the chance of store employees erroneously inputting data is reduced.

In general, processing, storing, and retrieving are performed at one location, the home office. Information exchange is fast and secure through use of the Internet and the virtual private tunnel. In addition, each store has access to the current inventory of every other store. Furthermore, inexpensive computers can be used as user interfaces at each store. The computers can be easily replaced without having to copy or restore data that is conventionally stored in a store computer's memory. Time and effort associated with maintenance of the applications and database are also reduced significantly because all repairs are performed at the home office. Similarly, all updating of the applications or the database is performed at one location only.

The point-of-sale online store management system may include a home office; a store including a processing device having communications software for conducting a point-of-sale transaction; a virtual private network connecting the home office and the store; and a digital form sent from the home office through the virtual private network to the processing device. The digital form may include a data entry field to solicit data used to conduct the point-of-sale transaction and the digital form is processed by the home office to complete the point-of-sale transaction.

The home office may include an application server that generates the digital form and processes the solicited data according to a corresponding application to conduct the point-of-sale transaction.

The home office may also include a router connected to the Internet and the store may include a router connected to the Internet, the routers forming the virtual private network between the home office and the store. Furthermore, the home office may also be a store. The home office can include a database for storing the solicited data.

In addition, the home office application server can retrieve information from the database when generating the digital form.

The communications software may include a browser that displays the digital form sent from the application server.

The home office includes a database and the application server retrieves information from the database when processing the point-of-sale transaction.

The home office may also store data derived from the processing of the solicited data in the database. The solicited data can include, for example, customer information and merchandise information.

The data may be sent between the home office and the store on the virtual private network is encrypted and authenticated to provide secure transactions.

A point-of-sale transaction may be conducted between a home office and store by providing a virtual private network between the home office and the store; transmitting a first interactive digital form from the home office to the store for display in the store; displaying the first form in the store; displaying a data entry field in the first form; entering data in said data entry field; sending the entered data to the home office; processing the entered data; transmitting a second interactive digital form from the home office to the store for display in the store in response to the entered data; and completing a point-of-sales transaction at the store based on the second interactive digital form.

A system for managing a store from a remote location may include an application server located at the remote location; a database connected to the application server; a processing device located at the store; and a virtual private network connecting the application server and the processing device. The data stored in the database is processed by the application server to generate digital forms that are sent to the processing device to conduct point-of-sale transactions at the stores.

Another point-of-sale online store management system may include a home office and a store connected by the Internet including an application server located at the home office; a processing device located at the store for conducting a point-of-sale transaction; a virtual private network connecting the application server and the processing device; a browser running on the processing device; and a digital form sent from the application server over the virtual private network for interpretation and display by the browser. The digital form includes a data entry field to solicit data used to conduct the point-of-sale transaction and the solicited data is processed by the application server to complete the point-of-sale transaction.

The details of one or more embodiments of the invention are set forth in the accompanying drawings and the description below. Other features and advantages will be apparent from the description, the drawings, and the claims.

### DESCRIPTION OF DRAWINGS

FIG. 1 is a block diagram of an example of a multi-store system.

FIG. 2 is a block diagram of an exemplary configuration of a home office.

FIG. 3 is a block diagram of an exemplary store configuration.

FIG. 4 is a diagram of an exemplary POS navigation window.

FIG. 5 is a screen shot of an exemplary customer search form.

FIG. 6 is a screen shot of an exemplary customer maintenance form.

FIG. 7 is a screen shot of an exemplary transaction form.

FIG. 8 is a block diagram of an exemplary rent-a-tire store configuration.

FIG. 9 is a screen shot of an exemplary purchase order search form.

FIG. 10 is a screen shot of an exemplary purchase order shipping and invoice form.

FIGS. 11A and 11B are flow charts of a rent-a-tire process.

FIGS. 12A and 12B are screen shots of an exemplary quote analysis form.

Like reference symbols in the various drawings indicate like elements.

### DETAILED DESCRIPTION

On Line Store Architecture

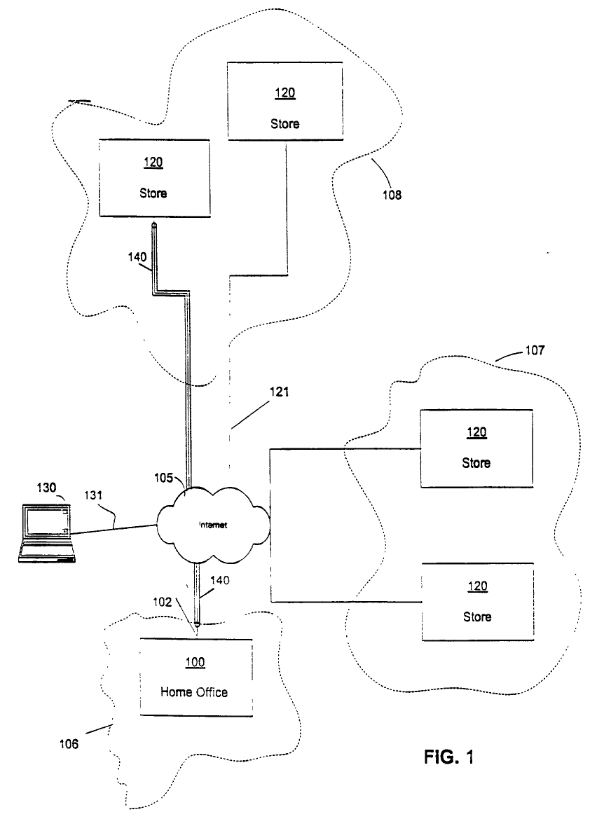

According to the example shown in FIG. 1, a home office 100 is located in a first geographic area 106. The home office 100 oversees the operation of a number of stores 120. The home office 100 may be located in a geographic area 106 that is separate from the stores 120 or in the same geographic area as a store 120. In addition, the stores 120 can be located in a number of distinct geographic areas 107 and 108.

The home office 100 is connected to each of the stores 120 through communications media, such as a connection 102 between the home office 100 and the Internet 105, and a connection 121 between the Internet 105 and a store 120. A virtual private network (VPN) 140 is formed between each of the stores 120 and the home office 100. The VPN 140 provides secure communications between the stores 120 and the home office 100. Store data is communicated over the Internet 105 through the VPN 140 to the home office. All POS transaction processing is performed at the home office. The home office 100, the stores 120, and the VPN 140 are described in further detail below.

Traveling managers and other authorized employees can connect to the home office 100 using a portable computing device 130 through a communications medium 131 and the Internet 105, which is also described in further detail below. As a result, the portable computing device 130 has access to any store's information. The portable computing device 130 can also perform all POS functions.

Home Office

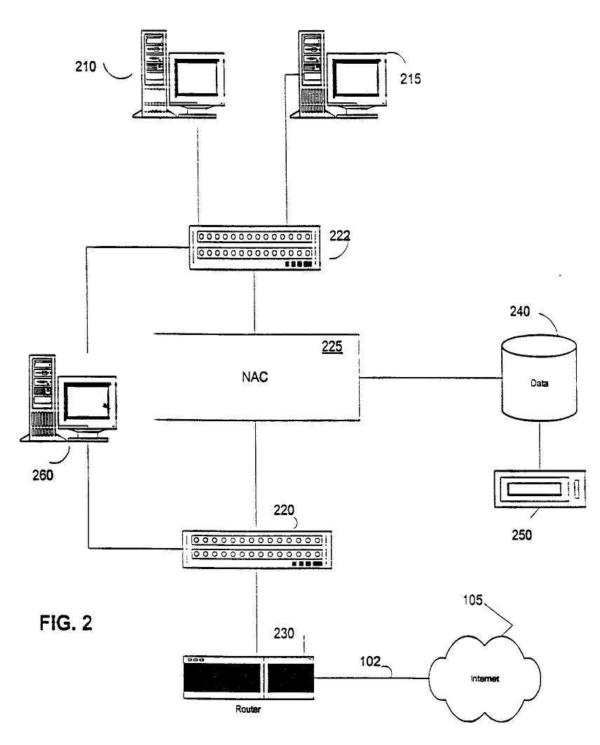

An exemplary configuration for the home office 100 is shown in FIG. 2. The home office 100 is provided with a router 230 that is connected to the Internet 105 through a communications line 102, such as, for example, a full or fractional T1 line. The router 230 has an Internet protocol (IP) address that is used by the stores 120 to identify the home office 100. The router 230 transmits transmission control protocol (TCP)/IP packets to the stores 120 and receives TCP/IP packets from the stores 120. When a packet is received at the router 230, the router 230 examines the packet header and checks the destination of the packet against a routing table stored in the router 230. After determining the packet's destination within the home office, the router 230 forwards the packet to its final destination. The router 230 uses an exterior routing protocol, such as an exterior gateway protocol, to route the packet within the home office. Packets received by the router 230, which are destined to be stored in the home office database 240 or processed by the application servers 210 and 215, are first routed to a hub 220 and then to a network alchemy cluster (NAC) 225.

The NAC 225 is the primary point of contact for the home office's connection to the Internet 105. The NAC 225 shields the home office network from unauthorized entry by non-employees. The NAC 225 includes a number of heavily protected servers, with built-in security provisions, to implement a firewall against unwanted intruders. In this way, the servers 210 and 215 and the database 240 of the home office network cannot be directly contacted from the Internet 105 and a high level of security is maintained.

After passing through the NAC 225, packets addressed to the home office's database 240 and the application servers 210 and 215 are connected to their destination through hub 222. Alternatively, hub 222 can be an interior router, such as, for example, a choke router, that examines all packets of data traveling to and from the home office 100 and the Internet 105. Data contained in the packet headers can be used to determine the source and destination of the packet, the protocol used to send the packet, and other identifying information. Therefore, an additional level of security can be provided to the internal network of the home office by screening this data using an interior router.

A proxy server 260 provides access to the Internet 105 by handling requests from the home office 100 and the stores 120 for access to the Internet 105. When an employee wants to access a server on the Internet 105, a request is sent to the proxy server 260. The proxy server 260 contacts the server on the Internet 105 having a requested IP address. The proxy server 260 receives the requested information from the Internet server and screens the information before authorizing transmission of the information to the requesting employee's computer. According to this arrangement, a single server can log, screen, and authorize requests for all material obtained from the Internet 105. In addition, all e-mail sent to and from the home office or the stores is screened and logged using the proxy server 260.

Processing for the store computers is provided by one or more application servers at the home office 100. In the example shown in FIG. 2, two application servers 210 and 215 are provided for handling all requests for processing used to conduct daily store operations. The application servers 210 and 215 run a number of applications or programs that are used to conduct POS and other store related transactions. The applications process requests for customer information, payments, credit approval, auditing and daily reporting, inventory control, home office management, purchasing, merchandise selection, employee time and attendance, accounting, and other POS transactions.

The application servers 210 and 215 can be implemented using, for example, Oracle application servers. The application servers 210 and 215 send data packets that are assembled into interactive multimedia documents by the communications software running on the store computer. The multimedia documents are interactive forms that can be implemented, for example, using Oracle forms. The interactive forms are sent to the store computer based on requests for processing received from the browser software running on the store computer. The application servers 210 and 215 receive data that is submitted in response to input from employees in the data entry fields of the interactive forms displayed. The received data is then processed according to the applications running on the application servers 210 and 215.

The application servers 210 and 215 also pass common gateway interface (CGI) scripts to CGI applications running on a database server, such as, for example, a data lookup, in response to requests for data used by the interactive forms. The application servers (210 or 215) can transmit data retrieved from the database 240 to the browser running on the store computer. The application servers 210 and 215 also send scripts (e.g., Java Applets) to execute on the store computers. The scripts handle the presentation and gathering of information on the store computers.

The database 240 provides storage for all data gathered from the stores 120. The database 240 also stores the results of any inquiries or requests for processing from the application servers 210 and 215. The database 240 can be located at the home office 100 or at the remote site. As an added protection against the loss of data, a tape storage library 250 is provided for daily backup of information in the database 240. Any number of servers can be used to implement the database 240.

Store Configuration

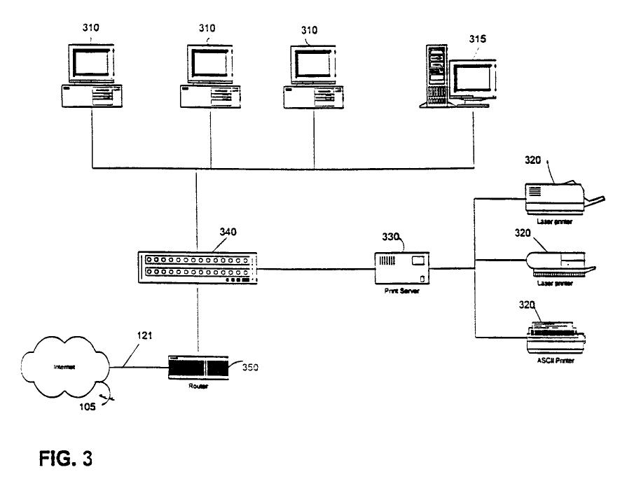

FIG. 3 shows an exemplary POS store configuration. The store 120 is connected to the Internet 105 through a communication line 121 and a router 350. The communication line 121 can be implemented using, for example, a full or fractional TI line. The router 350 can be implemented using, for example, a Cisco 5000-7000 series router. The store router 350 has a unique IP address that the home office 100 can use to identify and communicate with the store 120.

Each of the stores 120 and the home office 100 exchange data over the Internet 105 using a point-to-point protocol. An IP virtual private tunnel is established between the store router 350 and the home office router 230 to form a Virtual Private Network (VPN) 140. The VPN 140 may be implemented using, for example, a layer two-tunneling protocol (L2TP). The home office router 230 and the store router 350 run software that encapsulates internet bound data in a L2TP tunneling packet with encryption and counting functions. The L2TP tunneling packet is wrapped in a standard IP packet for transmission across the Internet 105. At the home office 100, the router 230 strips the L2TP packaging off the packets received from the stores 120 and sends the data to the hub 220 and the NAC 225 for verification. The store router 350 strips the L2TP packaging for transmissions received from the home office 100 and forwards the data to the hub 340. Other tunneling protocols could also be used to implement the VPN 140, such as, for example, IPSec Tunnels using data encryption standard (DES) and 3 DES. Hub 340 connects the store server 330 and the store POS computers 310 and 315 to the store router 350.

POS computers 310 are located in the store at locations where employees provide service to customers. In addition, a manager POS computer 315 having additional functionality can be located at the store 120 for uses such as report generation. The POS computers 310 and 315 are implemented using a processing device running communications software, such as, for example, a personal computer (PC) running internet browser and multimedia software. According to an exemplary embodiment, the browser software can process script applications. The POS computer 310 also includes a user interface that presents interactive multimedia forms to help employees conduct the store's daily operations.

Employees using the POS computers 310 are able to access a number of interactive forms that reside on the application servers 210 and 215 at the home office 100. The interactive forms allow employees to access the application servers 210 and 215 of the home office. The interactive forms are used by employees to perform store operations that include, but are not limited to, POS transactions, file maintenance, inventory, pricing, purchasing, customer data, sales analysis, management functions, e-mail, web browsing, reports, audits, paper trails, payroll, employee information, and scheduling.

Packets sent from the home office 100 encode data using a hypertext markup language (HTML) to generate the interactive forms. Other languages, such as, for example, XML, DHTML, SGML, Java, Javascript, Visual Basic, and Active X, can be used to generate the interactive forms. The forms are interactive multimedia documents that are interpreted by the browser for presentation on the POS computers 310. The interactive forms can include a number of multimedia aspects, such as visual effects and sound, among others.

The interactive forms allow the user to interact with the application servers 210 and 215 in a number of ways. The forms display interactive windows that include data entry fields. Users enter information in the data entry fields to request processing from and provide information to the home office 100. In addition, interactive buttons allow users to submit data, request activation of a process, or change an aspect of the display. Pull-down menus offer an additional way for users to manipulate display of the forms. The pull-down menus can be used to activate functions on the desktop of the POS computer or to access the interactive forms. Tabs are used to layer information for presentation to the user. A user can select a tab to reveal display information associated with the tab.

When a user desires to perform a POS transaction, the user selects a form corresponding to the desired POS transaction from a menu or navigation window. The application server transmits a form for display on the POS computer. A user enters information in a data entry field of the form. Once the information is entered in the data entry field of the form, the user sends the data to one of the application servers 210 and 215 in the home office 100. Data can be submitted, for example, by clicking a submit button to transmit the information to the home office 100. The data is encoded by a browser running on the POS computer 310 and sent to the store router 350. The store router 350 encapsulates the data in packets and transmits them over the Internet 105 to the home office 100 using the VPN 140. Upon receipt at the home office 100, the data is routed to the appropriate application server (210 or 215) for processing. The results of the processing are encoded in an HTML format, encapsulated in data packets, and sent through the VPN 140 to the POS computer 310 for display. In addition, the results are stored in the database 240.

Although no POS transaction processing is performed by the POS computers 310, the display of the forms, and the data populated in the fields of the forms, occurs in real-time. As a result, the user is unaware that processing is being performed at a remote location.

The application servers 210 and 215 also check data submitted in the data entry fields to determine if the data has been properly entered. If an error is found, or if required information is missing, the form is returned to the POS computer 310 or 315, and the erroneous or missing information is identified. The user can then correct the information and resubmit the form for processing.

A print server 330 is also connected to the hub 340 for servicing a number of printers. The printers generate receipts and transaction summaries as needed at the store 120. The POS computers 310 may also have an associated printer.

The POS computers 310 have access to Internet 105 through the proxy server 260 at the home office 100. The POS computer 310 establishes contact with the home office 100 through the routers 350 and 230. The request to access the Internet 105 is then forwarded to the proxy server 260 through the NAC 225 and the hub 222. The proxy server 260 then handles the requests from the POS computer 310, as described above. As a result, employees can perform searches of the Internet 105, for example, for product information. In addition, employees can send e-mail using the proxy server 260.

Traveling Stores

According to another aspect of the invention, store employees can communicate with the home office 100 through a portable computing device 130, such as, for example, a laptop, a personal data assistant, or a web pad. The portable computing device 130 can connect to the Internet 105 through a communications medium 131 using a communications device, such as a modem or wireless modem. An encryption key is stored in the portable computing device 130 and is used to ensure that communications between the portable communications device 130 and the home office 100 are secure. The portable computing device 130 encrypts data with a key unique to the portable device 130. At the home office 100, the router 230 receives the encrypted data and forwards it to the NAC 225. For verification, the NAC 225 decrypts the data and verifies the source of the data. The NAC 225 uses another encryption key to send data to the portable computer device 130, which can then verify that it is receiving authenticated data.

Using the portable computing device 130, a store employee has access to any store's data contained in the central database 240. As a result, customer service is improved, for example, by allowing for service providers to access customer information when visiting a customer's premises. In addition, the portable computing device 130 can perform all POS functions. As a result, sales transactions can be carried out at any location by, for example, a mobile store. For example, a vehicle could be loaded with merchandise and a mobile store can be set up in an area away from a store 120 where it is more convenient for customers to access.

Online Store Management

The following sections provide examples of interactive forms for running stores 120 on a day-to-day basis and other aspects of the POS management system.

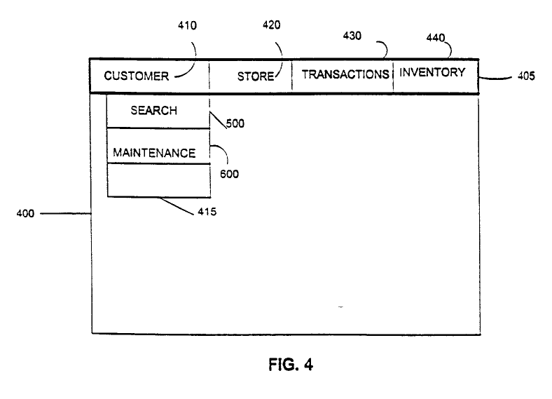

Upon powering a POS computer 310, the computer performs a diagnostic routine and then boots the operation system and communications software. After booting, a menu or navigation window 400 is presented allowing the user to select a desired application, as shown in FIG. 4. The navigation window 400 includes a tool bar 405 for accessing the interactive forms. A number of application categories, corresponding to the applications running on the application servers 210 and 215, are displayed on the toolbar or on a menu. Exemplary categories include customer 410, store 420, transactions 430, and inventory 440. Selecting categories from the toolbar, for example 410, causes a pull down menu 415 to appear. Individual forms (e.g., search 500 and maintenance 600) can be selected from the pull down menu 415 to navigate a user to a desired form.

Customer Information

Gathering and maintaining accurate customer information is an important function of the POS management system, because other management system programs, such as, for example, merchandise selection, payments, and marketing, use the customer information.

Customer information is also used for sales, promotions, and to facilitate further transactions with a customer. Information placed in the customer record is also an important element of corporate profit control. A feature of the software for the POS management system is the use of a cross-referenced database containing information such as, for example, a name, a home address, a work address, a home telephone number, a work telephone number, a cellular number, a pager number, spousal information, a social security number, and a driver's license number.

Marketing and demographic information is another element of the customer information program. The marketing and demographic information is used by management to target customers, customer merchandise preferences, and marketing areas. The information is also used by management to directly contact customers through mail, e-mail, telephony, or through personal contact. The ability to cross reference demographic marketing information directly affects the ability of the company to grow its market. The customer information that is gathered by the POS computer 310 provides the user definable marketing and demographic criteria.

Cross referencing information contained in the customer record with information contained in other existing customer records is one way that the POS management system provides a competitive advantage in developing new and existing markets in addition to identifying opportunities for increased revenue.

Customer Search Form

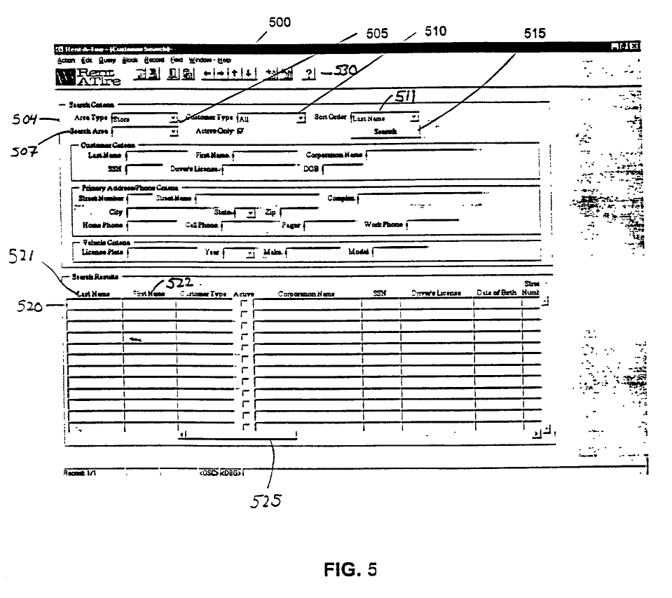

FIG. 5 shows an exemplary customer search form 500. The user navigates to the customer search form 500 using a menu in the navigation window 400. Once the customer search form 500 is displayed, the user may enter information identifying the customer in the search criteria block 504 and may perform a search of customer tables based on the specified search criteria. Only those fields in which the user has entered data are used in the search. If multiple fields contain search criteria, each of the entered criteria should be met before a record is returned in the search results block 520.

The user may specify where to perform the search by selecting the area type 505 and search area field 507. The user may select the high-level area to search, such as company, region, district, or store, using the area type field 505. Once the area type 505 is selected, the search area field 507 is dynamically populated. For example, if the user selects company as the area type, the search area field 507 will be populated with all the companies available. If the user selects store as the area type 505, the search area field 507 is populated with all the stores available. The value in the search area field 507 defaults to a value based on the store where the user is located. For example, if the area type 505 is company, the value in the search area field 507 will default to that store's company. If the area type 505 is store, the value in the search area field 507 defaults to that store.

In the customer type drop-down list 510, the user can specify whether the search will query for new customers, active customers, or all customer types. By selecting a new customer, the user can directly proceed to the customer maintenance form 600 to add the new customer's information.

Before selecting the search button 515, the user may also indicate a sort order in which the results are to be displayed. A drop-down list allows the user to select any one of the fields in the search results block 520. The sort order 511 should be selected before the search is performed. Each column in the search results block 520 is an option in the sort order 511 drop-down list. After a search has been performed, the user may change the sort order by conducting a new search and selecting a field in the sort order field 511. If no sort order is selected, the search will default to a sort ordered by the last name field 521. For all text fields, partial information may be entered, and the system will append a character to perform a “wildcard” search.

The following fields may be used as search criteria: last name, first name, corporation name, SSN, driver's license number, date of birth, and work phone.

Upon selection of the search criteria block 504, the cursor is placed in the last name field 521 and the first row is highlighted. If the user leaves the search criteria block 504 and later returns to the search criteria block 504, the cursor returns to the last name field 521 regardless of where the cursor was when the user left the search criteria block 504.

None of the text fields in the search criteria block 504 are dependent on any other text field within the block. In other words, data may be entered in any search field, regardless of the data contained in the other search fields. The user can enter search criteria in any or all of the fields in the search criteria block 504. If information is entered in more than one field for a single search, the system treats the search as a Boolean ‘AND’ of the search criteria (meaning all criteria must be met). Once the search button 515 is selected, any customers who meet the specified search criteria are returned to the POS computer and displayed in the search results block 520 of the form 500 in the order specified in the sort order field 511.

The results listed in the search results block 520 are scrollable both vertically and horizontally. The user may scroll vertically up and down through the result records, if more records are returned than can be displayed at once. The user may horizontally scroll left and right to display the various fields returned in the search. The horizontal scrollbar 525 does not affect the last name and first name fields since these fields are “locked” on the form and are always displayed. Therefore, the user can always see the customer name when scrolling through the other fields.

After a search has been performed, the user can scroll through the results listed to find the desired customer record. If the desired record is found, the user can highlight the record using a selection device, such as a mouse, then navigate to another customer-related form. For example, if the user highlights John Doe in the search results block 520 and navigates to the customer maintenance form 600, John Doe's personal information is retrieved by the application server 210 from the appropriate customer table in the database 240 and displayed in the customer maintenance form 600.

If a search is performed, and the desired customer record is not found, the user has the option of changing the search. Initially, the search is limited to a certain area (such as that store, region, or company). If the search does not return the desired record, the user can change the area type field 505 and/or the search area field 507 to widen the search. In addition, the user can change the search criteria 504 to redefine what search is performed. A clear button (not shown) on the toolbar 530 allows the user to reset the search form (i.e., blank out all criteria fields).

Customer Maintenance Form

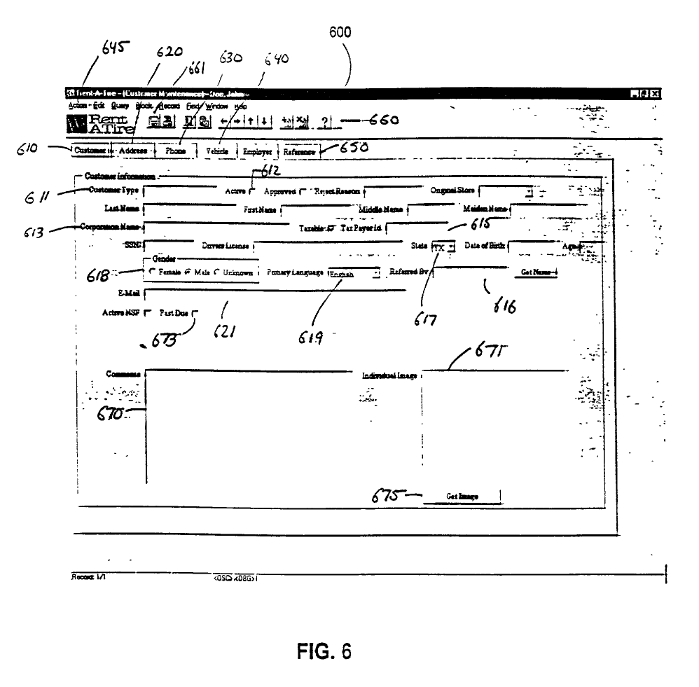

FIG. 6 shows an exemplary customer maintenance form 600. The customer tab 610 on the customer maintenance form 600 is used to enter and maintain personal details about the customer (such as name, SSN, driver's license, etc.). The user navigates to the customer maintenance form 600 through a navigation window 400. Once the customer maintenance form 600 is selected, the customer tab 610 is initially displayed. The user can work in the customer tab 610, or can select one of the other customer maintenance tabs, such as address/phone 620, employer 630, vehicle 640, or reference 650.

Using the customer tab 610, the user can view or maintain customer information. In addition, the customer tab 610 can be used to add new customer information to the database 240. To view information about a customer, the customer's record is activated upon entry into the customer tab 610. In other words, the user does not pull up an active customer's information using the customer tab 610. Instead the user selects the customer's record from another customer-related form and navigates to the customer tab 610 from that form. For example, the user can perform a search in the customer search form 500, locate the desired customer's record, highlight the record in the search results block 521, and navigate to the customer tab 610 using the navigation window 400. The application server uses the selected customer's identification number to perform a query of the relevant information in the database 240 and populates the customer tab 610 upon entry into the customer information form 600.

If the user wishes to add a new customer into the system, it does not matter how the user navigates to the customer tab 610. For example, if the user is not in a customer-related form immediately before navigating to the customer tab 610, a blank customer tab 610 will be displayed upon entry to the customer information. If the user is currently in a customer-related form and a customer's record is active, then that customer's record will be used to populate the customer tab 610. However, the user may then press the add record button in the action pull down menu 645 to pull up a blank customer tab (if necessary, the system will prompt to save the active record before blanking the form). Once a blank customer tab is displayed information about the customer may be entered into the customer data entry fields. The user can save the customer record by selecting the save button 661 on the tool bar 660.

The customer tab 610 can be used to find information about a customer, such as name, SSN, driver's license number, and gender. The customer type 611 is also displayed. The active checkbox 612 indicates the status of the customer. If checked, the customer record is active.

For corporate customers, the user can enter the company name in the corporation name field 613. Even if the customer is a corporate customer, an individual's personal information must be entered as a primary contact point at that corporation. In other words, an individual's name, SSN, driver's license number, and gender, as well as any other pertinent information should still be captured.

Initially, each customer is considered taxable (i.e., the taxable checkbox 614 defaults to checked. The customer taxpayer number may be entered in the taxpayer ID field 615. If the taxable checkbox 614 is unchecked, the taxpayer ID field 615 should not be populated. However, even if this field is populated, the customer will be charged taxes unless the taxable checkbox 614 is unchecked.

The driver's license state field 617 defaults to the state where the store is located. However, the user may change the state as required by selecting the appropriate state from a drop-down list (not shown).

The gender field 618 defaults to male, but female and unknown are also available.

The primary language field 619 defaults to English. However, the user may change the language as required by selecting the appropriate language from a drop-down list (not shown).

The referred by field 616 can be used to indicate the name of the person who referred the customer to the store. To select the name, the user will be taken to the referred by search form (a smaller version of the customer search form). Once the name has been selected, it will be displayed on this form.

An e-mail address can be captured for the customer in the E-Mail field 621.

The comments field 670 is available for the user to enter any information about the customer that cannot be captured in the other fields. The comments field 670 also displays on several of the other customer-related tabs, and any information entered in the customer tab 610, or some other tab, is also available in the other tabs. The comments field 670 is useful during the verification and approval process, as well as when providing information to maintain the customer's account. A customer image field 671 is provided in which a customer's image can be captured.

Customer records cannot be deleted from the system through the customer tab 610.

Payments Form

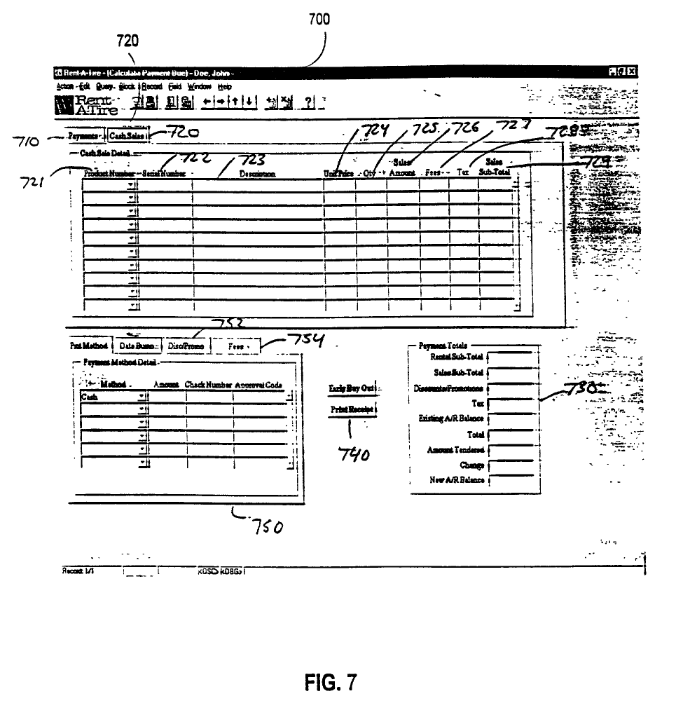

FIG. 7 shows an exemplary transaction payment calculation form 700. The form 700 can be used to calculate the payments due, for example, in the course of a sales transaction. A user can select payment type based on the customer's method of payment, for example, cash or credit. Details about the products can be entered and read by a user using the information fields of the form 700. In addition, the POS computer 310 can include a product information scanner, such as a bar code reader. When a user enters the product information or scans a product, a product number 721 or a serial number 722 is sent to the application server 210. The application server looks up the product information in the database 240. Based on the information returned from the database 240, the application server 210 populates the remaining fields of the price calculation form 700 with information, such as a description 723, a unit price 724, the quantity 725, the sales amount 726, fees 727, tax 728, and a sub-total 729. In addition, the applications server keeps a running total of the customer's purchases in the payment total window 730. When the transaction is complete, the user can print a receipt by selecting the print receipt button 740.

The form 700 also allows a payment plan to be established using the payments tab 710, if the store permits its customers to pay in installments under approved credit.

The price the customer pays may be adjusted using the payment method tab 750, discount or promotion tab 752, or the fees tab 754. Customer credit or check approval can be obtained using the payment method tab 750.

Auditing and Daily Reporting

The POS management system can perform auditing and daily reporting. The purpose of auditing and daily reporting is to provide stores a way of generating reports, which can be used to audit business processes. The reports consist primarily of exceptions, for example, manager overrides of the POS management system may be included in a report.

The following are examples of reports that may be used with the POS management system: payment exception, pricing exception, advertising leading to new accounts, inventory movement, inventory audit, weekly revenue, return to vendor, customer survey hit rate, store's monthly and daily product line/class, and inventory standard cost to purchase order cost compare. The reports are generated by the application server 215 from data stored in the database 240.

A daily operation summary form is also provided. The form provides the store manager and home office information concerning each store's performance. Information provided in this form includes total cash, number of active accounts, number of new accounts, account balances, past due balances, number of past due accounts, number of past due customers, receivables due, new units on hand, used units on hand, number of payments due today, amount of cash due today, amount of cash collected today, late fees collected today, receivables collected today, hours and employee budget available, monthly projected revenue/month-to-date revenue and percentages, daily payments/amount received and percentages, and retail sales information. The application server 215 also tracks multiple bank deposits throughout the day.

Inventory Control

The application servers 210 and 215 also provide an integrated purchasing system with inventory management and collection applications. The purchasing applications have the ability to check inventory from other stores using user definable parameters before issuing a purchase order. Once availability and pricing have been determined, the application servers 210 and 215 may issue a purchase order to the appropriate vendor over the Internet 105 using the VPN 140.

If an item is not located in an inventory, the home office 100 or a store 120 may order products from a vendor. The home office 100 or store 120 inputs desired products using an interactive form. The application server 210 or 215 creates a purchase order and stores the order in the database 240. The vendor may access the database 240 using the Internet 105 to determine if there are any new purchase orders for the vendor. The vendor may accept or reject any new orders. If the vendor rejects the order, the database 240 is updated to reflect the rejection and a new purchase order may be created for another vendor, if desired. If the vendor accepts the purchase order, then the database 240 is updated to mark the purchase order as shipped. After a purchase order has been marked shipped, no further changes may be made.

After the items are received, the database 240 is updated. The vendor may access the application server 210 or 215 to create an invoice for the received items. The invoice is stored in the database 240. The home office 100 may mark the invoice as approved for payment. The application server 210 or 215 updates the database 240 and accounts payable.

The purchase order application also interfaces with the inventory application to allow the purchasing of user definable inventory items. For example, a vendor may offer five different models, however, only one model may be authorized for sale in a store 120. The purchase order application only authorizes those models that are approved for sale. Managers can override the application, for example, using the manager POS computer 315, to special order non-store merchandise. Exception reports may be automatically generated in those instances.

The purchase order applications also interface with, for example, bar code readers that scan merchandise when inventory is received. Bar code labels are generated and inventory is updated as merchandise is received or transferred into the store. Receiving documents and detailed reports also may be generated by the applications.

All purchase order information in the stores is updated at the home office 100 in the database 240. The home office 100 controls store purchasing and provides the ability to cancel back orders or drop back orders. The home office 100 also has the ability to freeze purchasing, transfers, purchases from particular vendors, and special orders.

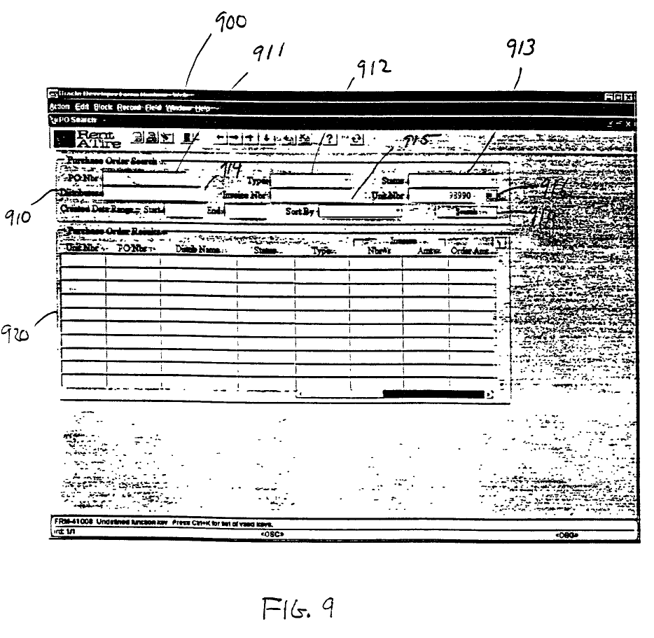

As shown a FIG. 9, a purchase order screen 900 allows a user to search for purchase orders stored in the database 240. The screen 900 includes a purchase order search area 910 that allows a user to search for purchase orders using any of the search criteria fields, such as, for example, a purchase order number 911, a type 912, a status 913, a distributor 914, an invoice number 915, or a unit number 916. After entering information in a search field a user may search for purchase orders by selecting the search button 918. The results of the search are displayed in the purchase order results area 920.

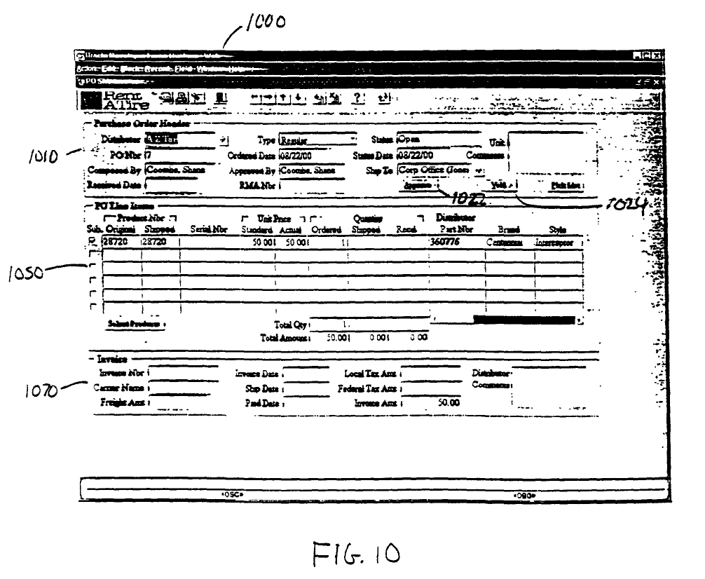

Details for a specific purchase order may be displayed using a ship/invoice screen 1000 as shown in FIG. 10. The purchase order line items 1020 includes information about ordered items, such as, for example, product numbers, serial numbers, unit prices, quantities ordered, shipped, and received, distributor numbers, brands, styles, and total cost. The purchase order header 1010 contains information, such as, for example, the distributor, the purchase order number, the order date, the status date, and the received date. In addition, buttons 1022 and 1024 may be used to approve and void orders. An invoice section 1070 includes an invoice corresponding to the displayed purchase order.

Each vendor that supplies merchandise to the stores 120 supplies the purchase order (net cost) amount that must be paid for a specific item. The item's net cost amount is used in establishing the item's standard cost. The standard item cost is the basis for all product pricing stored in the database 240.

After a relationship with a vendor is established, vendor information is input into the database 240 and the vendor is granted access to the management system for the purpose of accepting purchase orders and creating invoice. The corporate merchandise manager may select a new vendor form to enter the vendor information. After the basic information about a vendor has been entered, the purchasing application validates that a vendor with the same name does not currently exist in the database 240 and the vendor information is added.

Time and Attendance

The time and attendance information provides managers a way of maintaining information about employees, clocking in/out of the system, logging in/out of the system, requesting time off, managing time punch records, and importing/exporting batches.

The following functions can be performed by the time and attendance application forms: employee list (search), employee maintenance, employee time, manage time off, clock in/out, change password, change store, security profile list, security profile maintenance, security object list, security object maintenance, security profile/object assign, security profile/user assign, accounting batch search, and maintain batch/create new batch.

Rent-to-Own

The following exemplary embodiment shows the implementation of the online POS management system in a rental store system.

In general, rental-purchase firms service a neglected market segment that is often ignored by traditional retailers. Rental-purchase stores typically rent household durable goods, such as, for example, appliances, consumer electronics, and furniture to customers on a weekly or monthly basis. A rental-purchase transaction is not a retail sale. Instead, a rental purchase company retains ownership of the merchandise until the customer makes the required number of rental payments.

After a prescribed number of rental payments, ownership passes to the customer. However, the customer has the option of purchasing the merchandise for a cash pay-off amount, typically calculated by a preset formula, at any time during the rental process. Rental periods for ownership vary depending on whether the merchandise is new or has been previously rented.

Despite signing an agreement to make payments over a certain period of time, customers are not under any obligation to rent the item for the entire rental period. The average rental period lasts only four months. The customer selects the merchandise and determines what type of payment plan best fits the household budget. After the customer completes a rental application containing all pertinent employment and personal information, store personnel check the customer's personal references and verify employment. Approval usually takes little time because credit checks are not required. While few customers fail the approval process, a customer service representative may persuade the customer to rent a lower priced item, or to take a longer rental term, if the initially proposed rental would strain the customer's budget.

Rental purchase stores typically do not require a down payment or security deposit. However, the stores do require the customer to make the first weekly or monthly payment in advance. Although not required, many customers elect to protect themselves from fire, theft, or other damage by purchasing a damage waiver.

Delinquencies run 6%-15% on outstanding rental agreements, and can turn into significant lost revenue if not monitored closely and resolved quickly. Despite this high delinquency rate, actual write-offs due to customer skips, stolen merchandise, and product damage average 2%-4% for the entire industry. Two factors account for this low rate. First, a store manager works with the customer to arrange for late payment, and, even if significantly late, the customer can be reinstated to the original rental agreement after paying a fee. Second, if a customer cannot or will not pay, the rental company picks up the merchandise free of charge.

Since customers are not obligated for any debt and do not suffer adverse effects on their credit if the rental company reclaims the merchandise, they are less likely to steal the merchandise. However, it is import for the rental stores to have accurate and up to date information about the customer, including where the merchandise can be located, in case the merchandise does need to be repossessed.

Rent a Tire Store

Rent-A-Tire Stores

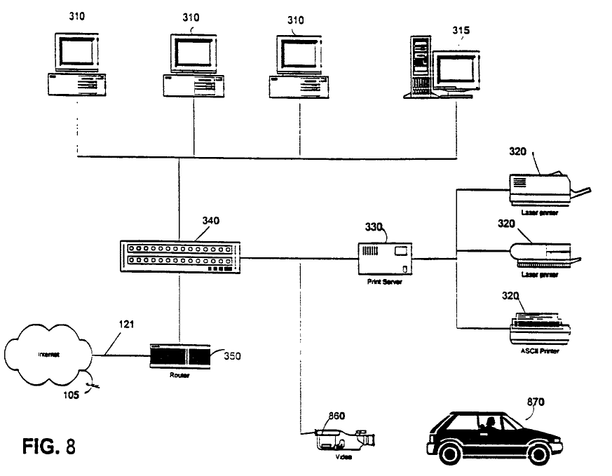

The online POS management system can be configured as shown in FIG. 1, in which a number of rent-a-tire stores 120 are connected to a home office 100 through a VPN 140. The rent-a-tire stores 120 can be configured as shown in FIG. 8. The rent-a-tire store 120 operates according to the description given for FIG. 3; however, the rent-a-tire store 120 can additionally include a video server and digital camera 860 to capture an image, for example, of a customer's car 870.

Each store 120 is provided with a combination of counter clerks, assistant store managers, and store managers. While some of the store personnel may have previous experience selling tires and wheels, or have experience in the rental industry; other personnel may have little or no previous experience (receiving on the job training). Therefore, using the interactive forms and online POS management system, a rent-a-tire system can be implemented that simplifies the training of inexperienced employees. Using the online POS management system based approach, the interactive forms are generated to be simple to use. In addition, the interactive forms are the same for each store. As a result, store managers and personnel can travel between stores without having to learn new procedures. Many of the interactive forms and their associated applications are self-checking and automatically update or populate other related forms. As a result, store personnel do not have to repeatedly input information, which reduces the chance for accidental and erroneous data entry.

Rent-A-Tire Process

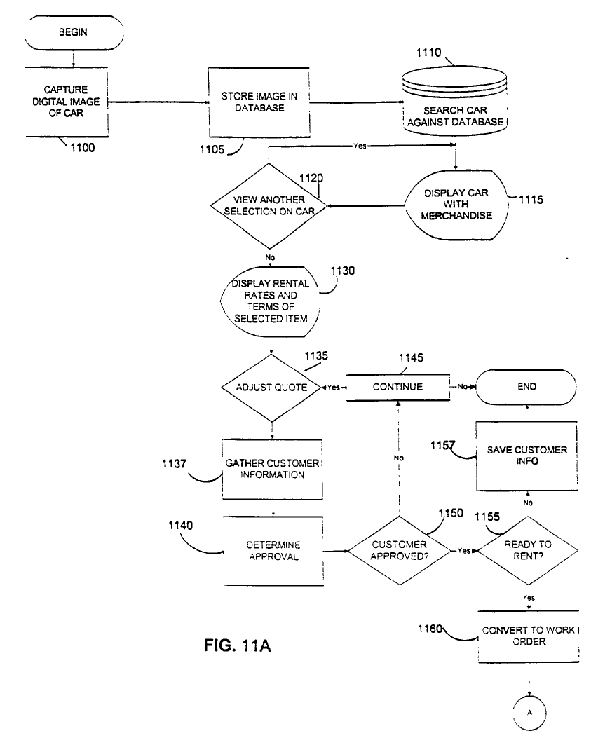

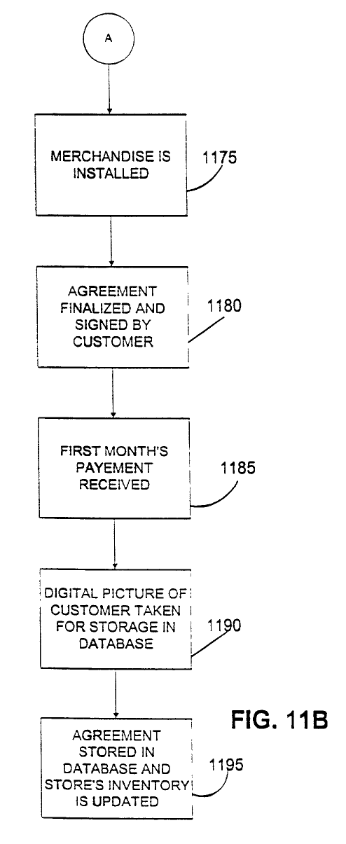

One exemplary method of a rental process for renting tires is shown in FIGS. 11A and 11B. First, a store employee captures a digital image of the customer's vehicle 870 using a digital camera or video camera (step 1100). The digital image of the car is sent from the video server 860 through the hub 340, to router 350, through the VPN 140, and to the home office 100 (step 1105). The application server 210 at the home office receives and stores the digital image in the database 240. The application server 210 at the home office 100 performs a search using the database 240 to determine what tires, wheels, and other merchandise are suitable for mounting on the customer's vehicle (step 1110). The results of the search are used by the application server 210 to generate images of the customer's car with the wheels, the tires, and the other merchandise mounted on the car. The generated images are sent to the browser operating on the store personal computer 310 for display to the customer (step 1115). The customer is then able to view any of the selected inventories with the wheels, the tires, and the other merchandise superimposed over the digital image of the customer's vehicle. The customer can view different styles, or perform additional searches, until the customer finds a desired product (step 1120). As a result, a sales person, who may have limited tire and wheel knowledge, has the ability to show the customer wheels and tires that will fit the customer's vehicle.

In addition to capturing an image of the customer's car, a descriptor or other search identifier can be used to select a pre-stored image of the type of car that belongs to the customer. The images also may be selected or modified to resemble the customer's car by taking into account the color and modifications found on the customer's car. The selected wheels, tires, and other merchandise can then be shown with the customer's car. A search for the wheels, the tires, and the other merchandise can also be performed based on the customer's car model. Images or other identifying information of the products suitable for the customer's car can be presented to the customer based on the results of the search. An image of the merchandise uninstalled or installed on a generic vehicle also may be shown to the customer.

The results of the inventory search for merchandise that match the customer's car are displayed in the following order: 1) used on-hand inventory; 2) new inventory on-hand; 3) on-hand inventory at other locations; and 4) models available for special order. The customer's selection is captured by the system and a quote is determined for display to the customer (step 1130). The quote is displayed to allow the customer to find an affordable payment. The sales person can adjust the quote by changing the term of the rental period and amount of the payments (step 1135). The interactive forms displayed at the sales person's store computer automatically provide default-pricing parameters that the sales person can use to initiate discussion or provide suggestions. The quote captures the rental rate, the term, and the selected inventory.

After determining a quote, customer information is gathered by the sales person (step 1137). The customer information is input in the system (step 1140). If the customer information is not validated, the transaction is not completed (step 1145). If the customer information is validated, the customer is given the option to continue with the transaction and rent the item (step 1155). If the customer is not ready to rent at that time, the quote is saved for future reference (step 1157).

As soon as the final quote is entered into the online POS management system, a work order can be displayed and printed (step 1160). The work order is used by the store technicians to pull the inventory and provide installation instructions for the customer's car.

The merchandise selected by the customer is then installed (step 1175). In addition, the agreement can be finalized after the customer has approved the work (step 1180). The initial payment is made upfront (step 1185). In addition, a digital picture of the customer is taken and stored in the database 240 to aid future location of the customer, for example, in the instance of delinquent payments (step 1190). Finally, after completion of the agreement, the agreement is stored in the database 240 and the store's inventory is automatically updated (step 1195).

Rental Store Management

Customer Maintenance

As in the POS system described above, the customer information system is an important part of the rental tire online POS management system. Other core programs, such as merchandise selection, rental agreements, payments, collections, and marketing, interact with the customer information. Customer information required for a rental purchase operation is more detailed than the traditional retail operation. The rental-purchase transaction allows these customers to obtain necessary or desired items without long-term credit obligations giving them an opportunity to acquire ownership after making a set number of rental payments. The rental-purchase customer is often employed and may have several family members contributing to the household budget. Most pay their bills in person by cash or by money orders. As a result, rental purchase customers present a unique challenge for collections and marketing. The ability of management to verify information about the customer, such as, for example, a personal relationships that they have with family, friends, and employees, is usually the criteria that determines whether the customer is approved for the rental-purchase account.

The information regarding the customer is also used to contact the customer if the account becomes delinquent. A rental-purchase transaction is not a retail credit sale. Failure to pay on the account does not adversely affect the customer on a credit report. The rental-purchase transaction relies on an agreement between the customer and the rental-purchase company. The customer can use the rented item as long as the payments are made per the agreement. In essence, the customer is renewing the rental transaction with each payment. Therefore, the ability of the rental-purchase company to contact the customer is the only real link to the merchandise. As a result, it is important to keep accurate and updated data on each customer.

Using the POS online management system, customer information can be stored in a cross-referenced database 240 containing information, such as, for example, a name, a home address, a work address, a home telephone number, a work telephone number, spousal information, a social security number, a driver's license number, a vehicle identification number, an auto tag number, lien holder information, personal references, primary language information, a map code, and a year, a make, and a model of the vehicle. A digital image of the customer and the vehicle can also be stored. The information is used to contact the customer and recover the property if the account becomes delinquent.

The customer maintenance form 600 can be used to gather the pertinent information as explained above with regard to the online POS management system. In addition, the past due checkbox 673 can be checked if the customer is past due on a payment. When the customer's rental agreements are brought up to date, or paid off, the checkbox 673 is cleared. The comments field 670 stores any information about the customer that cannot be captured in the other fields. The individual image field 671 stores a picture of the customer/applicant/lead to be stored. The user can press the get image button 675 to populate the field with an image from a camera.

Rental Agreement

The rental agreement is based on the initial quote given to the customer. The quote is used to determine a payment that is affordable and is ultimately used to generate the rental agreement.

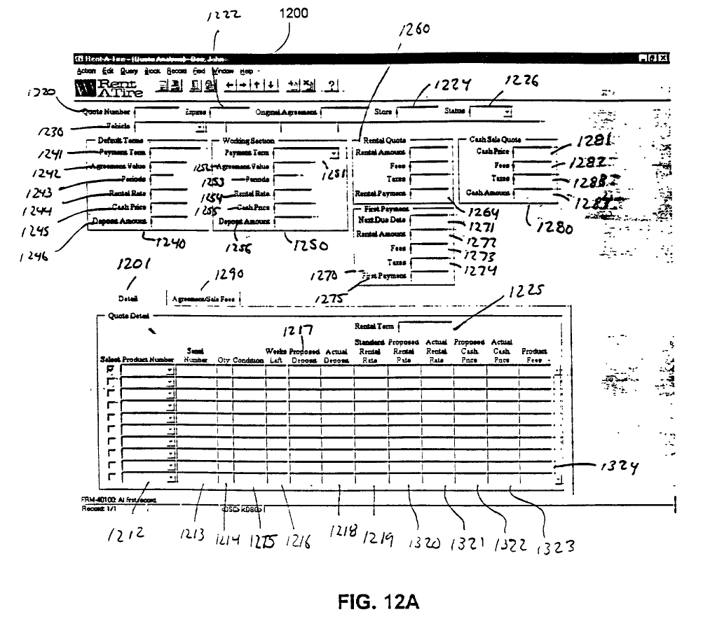

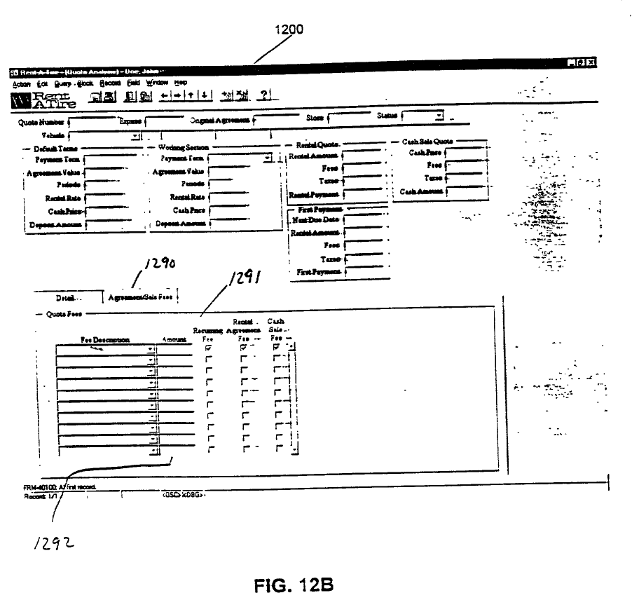

The quote analysis form 1200 as shown in FIG. 12 is used by store employees to generate a quote for sales or rental of merchandise. The quote analysis form 1200 is an example of an interactive self-checking form. The form automatically updates certain fields and checks others to reduce user data entry error.

Before a rental agreement is created, a quote can be generated to present to the customer. Using the quote analysis form 1200, the user can perform an analysis of the quote terms and adjust them in order to arrive at an agreement with terms for the rental transaction that are tailored to the customer.

The user can navigate to a quote analysis form 1200 using a navigation window, such as navigation window 400. The quote analysis form 1200 is populated as follows. First, the user may select merchandise in a merchandise selection form, which is used to populate the quote detail block 1210 on the detail tab 1201 of the quote analysis form 1200. If no merchandise is selected before entering the quote analysis form 1200, the quote detail block 1210 is initially display with blank fields. Second, the user may select a quote or agreement in the agreement list form, and the information from the quote or agreement being used to populate the quote detail block 1210. If no quote or agreement is selected before entering the quote analysis form 1200, the form is initially displayed with blank fields.

If the user selects merchandise in a merchandise selection form, and navigates back to the quote analysis form 1200, the new items are appended to the bottom of the original items in the quote detail block 1210 on the detail tab 1201.

When the quote analysis form 1200 appears a number of fields are displayed. For example, the quote number 1220 is the unique identifier for the quote, which is automatically calculated by the application server 210. A quote number is used as the agreement number if the quote is later converted to an agreement.

Expires field is the date calculated by the application server when the quote expires, which is defined by the system administrator (e.g., 7 days beyond the system date when the quote was initially created). The user has the ability to change this date to either extend or shorten a quote expiration date. Expired quotes are automatically purged from the system database 240 periodically.

The store field 1224 contains the store where the quote is created. The store field 1224 is automatically populated with the store at which the user is logged in.

The status block 1226 contains the status of the quote or agreement. Only quotes may be opened in the quote analysis form 1200, and the status field displays “Quote.” In other words, the user may select a “Quote” from an agreement list form and navigate to the quote analysis form 1200. However, if the user selects an “Active” or “Closed” agreement, and then attempts to navigate to the quote analysis form 1200, the system displays an error message informing the user why the navigation is not allowed. Once a quote is displayed in the quote analysis form 1200, the user may change the status from “Quote” to “Active.” When the user leaves the Status field, the system performs the following checks: all items in the quote detail section are serialized; all items in the quote detail section are currently “In Stock”; the next due date (first payment block) is greater than the current system date; if the items on the quote require vehicle information to be collected, the vehicle field contains a customer's vehicle; and the customer has been “Approved” by a store manager. If the quote passes these checks, the status is changed to “Active.” Once the quote analysis form 1200 has been saved as “Active,” rental payments may be taken for the new agreement. The user may then print a rental agreement for the customer's signature.

The vehicle field 1230 contains the customer's vehicle. If the user has previously selected a customer, that customer's active vehicle is used to populate the vehicle field 1230. The user may select a vehicle for the quote by highlighting the vehicle from a list of vehicles (not shown). The vehicle's license plate is displayed in the vehicle field 1230, and the vehicle's year, make, model, and model option is displayed to the right of the vehicle field 1230.

The default terms block 1240 contains the default values initially determined when the quote is created based on the items selected in the detail tab 1201. The values of the fields in this block change based on the items selected in the quote detail block 1210 on the detail tab 1201. If the payment term field in the working section block 1250 is changed, the values in the default terms block 1240 reflect the defaults based on the new payment term selected. No other changes by the user affect the values of the fields in this block. The fields in this section will recalculate (if appropriate) immediately when any of the changes described above occur.

The payment term field 1241 is a display-only field showing the payment term selected for the quote. This is the same as the payment term 1251 selected in the working section block 1250, but is displayed in the default terms block 1240 to indicate the payment term effective for the fields in this block. When the payment term (working section block 1250) field 1251 is changed, the payment term (default terms block 1240) field 1241 is immediately changed. This field should be set before the agreement value, periods, and rental rate fields in the default terms block 1240 may be calculated.

The agreement value field 1242 is the total rental value initially calculated for the quote before any adjustments are made by the user. The agreement value is calculated by multiplying the sum of the proposed rate (quote detail block 1201) fields 1320 for the selected items by the periods (default block) field 1243, and is not at all based on the agreement value field 1252 in the working section block 1250. In the default terms block 1240, the proposed rates 1320 are used for this calculation, regardless of any user changes to the actual rates. The periods field 1243 is calculated first, then agreement value 1242 followed by the rental rate 1244.

The periods field 1243 is the number of periods, based on the payment term (default terms block 1240) field 1241, estimated to pay the total agreement value of the items on the quote. The periods field 1243 is calculated by first selecting the maximum value in the weeks left 1016 column for the selected items in the quote detail block 1201, then multiplying or dividing this number according to the value of the payment term field 1241. For example, if the payment term is weekly, the maximum value will be the value for the periods field. If the payment term is biweekly, the maximum value will be divided by 2 to get the value for the periods field (rounded up to the next whole number). If the payment term is monthly, the maximum value will be divided by 4.3333 to get the value for the periods field (rounded up to the next whole number). If the payment term is semi-monthly, the maximum value will be divided by 4.3333, then multiplied by 2, to get the value for the periods field (rounded up to the next whole number).

The rental rate field 1244 is the periodic rental rate (no fees or taxes) calculated by the application server 210 based on the information displayed in the default terms block 1240. The rate is calculated by dividing the agreement value (default terms block 1240) 1242 by the periods (default terms block 1240) 1243.

The cash price field 1045 is the total cash price (no fees or taxes) of the selected items in the quote detail tab 1201 or block 1210. The cash price is calculated by summing the proposed cash price 1322 (quote detail tab 1201 or block 1210) fields for the selected items.

The deposit amount field 1246 is the total recommended deposit for the selected items. The deposit amount is calculated by summing the proposed deposit 1217 (quote detail tab 1201 or block 1210) fields for the selected items.

The working section block 1250 is initially populated with values that are exactly the same as the values in the default terms block 1240, though different fields in the quote detail tab 1201 or block 1210 are used for the calculations. However, each field in working section block 1250 allows the user to change or override these default values. Any changes of the values in these fields are stored in the respective field's actual value. The values in the default terms block 1240 are stored in the respective field's default value. As a result, the user can perform a “what if” analysis on the quote to see the impact of any changes and assist the customer in determining the best personalized payment method.

The payment term field 1251 is used to set the payment term (Weekly, Biweekly, Semi-Monthly, or Monthly) for the fields in the working section block 1250. In addition, if the payment term (working section block 1250) field 1251 is changed, the new value of the field is used to populate the payment term (default terms block 1240) field 1241 once the user leaves the payment term (working section block 1250) field 1251. The user selects the desired payment term from a drop-down list.

The agreement value field 1252 is the total rental value of the quote, and is calculated by multiplying the sum of the actual rate (quote detail tab 1201 or block 1210) field 1321 for the selected items by the value in the periods (working section block 1250) field 1250. When the quote analysis form 1200 is initially opened creating a new quote, the value in the actual rate (quote detail tab 1201 or block 1210) field 1321 for each item is the same as the value in the proposed rate (quote detail tab 1201 or block 1210) field 1320. Therefore, initially, the agreement value (working section block 1250) 1252 is the same as the agreement value (default terms block 1240) field 1242. However, the user has the option of overriding these proposed rates for the items in the quote detail tab 1201 or block 1210 individually. If the user overrides the proposed rates, the new values are used to calculate the agreement value (working section block 1250) field 1252. The user also has the ability to type in a new value in this field, and the new value is used to recalculate the actual rental rate 1321 in the quote detail tab 1201 or block 1210.

Any changes to fields in the quote detail block 1210 on the detail tab 1201 automatically update the agreement value field 1202 in the working section block 1250. If changes are made to the agreement value field 1252 in the working section block 1250, any affected fields are recalculated when the user leaves the agreement value (working section block 1250) field 1252. Finally, if the manual or automatic change to the agreement value 1252 causes the product of the Rental Rate and the Periods to differ from the agreement value, a modal window (not shown) is displayed to allow the user to correct the discrepancy. The modal window can display the following message: “The agreement value field was changed. Either the Periods field or the Rental Rate field must be modified before the quote may be saved.” Below this message, three buttons are displayed: change periods, change rental rate, and cancel. If the change periods or change rental rate buttons are pressed, the appropriate field is modified to make the equation balance. If the cancel button is pressed, the system does not change anything.

The periods field 1253 is the number of periods, based on the payment term (working section block 1250) field 1251, estimated to pay the total agreement value of the items in the quote. The purpose of the periods field 1253 is to calculate the periodic rental rate based on the total agreement value of the items. The periods field 1253 is initially calculated just as the periods field 1243 in the default terms block 1240 (see above). However, the user has the ability to type in a new value in this field. In addition, if the user makes changes to fields in the quote detail tab 1201 or block 1210, the system automatically checks to ensure that the periods (working section block 1250) field 1253 is equal to the agreement value field (working section block 1250) 1252 divided by the rental rate field 1254 (working section block 1250). If a discrepancy is detected, a modal window (not shown) is displayed to allow the user to correct the discrepancy as described above.

In addition, when the value in the periods (working section block 1250) field 1253 is changed, the system ensures that the standard and maximum rental terms are not violated for each item. For example, for each item, the applications server 210 checks that the periods (working section block 1250) value 1053 does not exceed the standard weekly or monthly rental term for that item (depending on which term is selected). If this standard value is exceeded, an informational message is displayed, but the quote may still be saved. The applications server 210 also checks that the periods (working section block 1250) value 1253 does not exceed the maximum weekly or monthly rental term for that item (depending on which term is selected). If this maximum value is exceeded, an error message is displayed, and the quote may not be saved until the error is corrected.

The rental rate field 1254 is the periodic rental rate (no fees or taxes) initially calculated by the system by dividing the agreement value 1252 (working section block 1250) by the periods (working section block 1250). However, the user has the ability to type in a new value in this field. In addition, for any change, which requires the rental rate (working section block 1250) field 1254 to be modified, the application server 210 automatically checks to ensure that the rental rate field 1254 is equal to the agreement value field 1252 (working section block 1250) divided by the periods field (working section block 1250) 1253. If a discrepancy is detected, a modal window is displayed to allow the user to correct the discrepancy as described above.

The cash price field 1255 is the total cash price (no fees or taxes) of the selected items in the quote detail tab 1201 or block 1210. It is calculated by summing the actual cash price (quote detail tab 1201 or block 1210) field 1323 for the selected items. The user also has the ability to type in a new value in this field, and this new value is used to recalculate the actual cash price (quote detail tab 1201 or block 1210) field 1323. If the user changes the cash price (working section block 1250) field 1255, the values of the actual cash price (quote detail tab 1201 or block 1210) fields 1323 for the selected items are proportionately updated when the user leaves the cash price (working section block 1250) field 1255. If the user changes the values in the actual cash price (quote detail tab 1201 or block 1210) field 1323, the change is automatically reflected in the cash price (working section block 1250) field 1255 when the user leaves the field. The changes to these selected items are discussed below in the quote detail tab 1201 or block 1210 section.

The deposit amount field 1256 is the deposit to be collected for the agreement. The deposit amount is initially calculated by summing the actual deposit 1218 (quote detail tab 1201 or block 1210) column for the selected items. The user has the ability to type in a new value in this field, and the actual deposit (quote detail tab 1201 or block 1210) fields 1218 of the selected items are changed proportionately.

The rental quote block 1260 fields are initially populated based on values in the working section block 1250, in addition to the values on the agreement/sale fees tab 1290. The rental block quote 1260 displays information that is pertinent only if the customer decides to rent the merchandise on the quote.

The rental amount field 1261 is the estimated periodic rental rate (no fees or taxes) for the selected items on the quote. The rental amount is a display-only field that is copied from the rental rate (working section block 1250) field 1254, and is displayed to allow the user to easily see how the rental amount, fees, and taxes combine to make up the normal estimated rental payment. If the rental rate (working section block 1250) field 1254 is changed (either manually or automatically), the rental amount (rental quote block 1260) field 1261 automatically changes.

The fees field 1262 is the total recurring fees that are applied to every payment throughout the rental agreement. The fees field is display-only, so the user must change, add, or waive fees on the agreement/sale fees tab 1290 as shown in FIG. 10B. Any changes on the agreement/sale fees tab 1290 are reflected immediately in the blocks on the quote analysis form 1200 when the user leaves the changed field.

The taxes field 1263 is the total taxes for the rental quote. The taxes field is set to zero if the customer is non-taxable. Otherwise, it is calculated by multiplying the sum of the periodic rental rates for taxable items and fees by the store's tax rate. This field is automatically recalculated whenever a change is made that impacts tax.

The rental payment field 1264 is the total expected periodic payment amount for the rental if the customer makes regular on-time payments. The rental payment is calculated by adding the rental amount (rental quote block 1260) field 1261, the fees (rental quote block 1260) field 1262, and the taxes (rental quote block 1260) field 1263.

The first payment block 1270 displays the amounts of the first rental payment, and is initially populated based on values in the working section block 1250, in addition to the values on the agreement/sale fees tab 1290. The first block payment 1270 displays information that is pertinent only if the customer decides to rent the merchandise in the quote.

The next due date field 1271 indicates the date the first scheduled payment must be made. It is initially populated with a date one period beyond the current system date, based on the payment term (working section block 1250) field 1251. For example, if the payment term is set to weekly, the next due date field is populated with a date 7 days beyond the current system date (14 days for Biweekly, 15 days for Semi-Monthly, and 30 days for Monthly). If the user opens a quote previously created and saved, and the next due date is less than or equal to the current system date, the system increases the date as described above. The user then has the ability to change this date, which then changes the amount calculated in the first payment field.

The rental amount field 1272 is the rental amount (no fees or taxes) for the selected items based on the next due date (first payment block 1270) field. The rental amount is a display-only field that is calculated by converting the rental amount (rental quote block 1260) field 1261 into a daily rental amount, then multiplying the result by the number of days until the next due date (first payment block 1270) field 1271. To calculate the daily rental amount, the system divides the rental amount (rental quote block 1260) field 1061 by the payment term days (e.g., 7 for Weekly, 14 for Biweekly, 15 for Semi-Monthly, and 30 for Monthly). If the rental rate (working section block 1250) 1254 or the next due date (first payment block 1270) field 1271 is changed, the rental amount (rental quote block 1260) field 1261 is recomputed.

The fees field 1273 contains the total fees that are applied to the first payment only. The fees field 1273 includes the recurring fees, as well as one-time fees (such as a processing fee or a recycling fee). For recurring fees, the amount of the fee used in this calculation is based on the number of rental payments being quoted for the first payment. If the next due date is more than one rental period but less than two rental periods from the current system date, then the amount of the individual fee is double, and so on. For example, on a Weekly quote where the current system date is Sep. 9, 1999 and the next due date is Sep. 9, 1999, a $5/week club fee would be applied twice, resulting in a $10 fee for the first payment. This field is display-only, so the user must change, add, or waive fees on the agreement/sale fees tab 1290. Any changes on the agreement/sale fees tab 1290 are reflected immediately in the blocks on the quote analysis form 1200 when the user leaves the changed field. However, to change or waive the individual amounts for the first payment only, the user must do so in the calculate payment form at the time of the first payment.

The taxes field 1274 contains the total taxes for the first payment. The field is set to zero if the customer is non-taxable. Otherwise, the field is calculated by multiplying the sum of the rental amount for taxable items and fees by the store's tax rate. This field is display-only and is automatically recalculated whenever a change is made that impacts tax.

The first payment field 1275 is the expected first payment amount, assuming the customer executes the rental agreement on the current system date. The first payment is calculated by summing the rental amount (first payment block 1270) field 1272, the fees (first payment block 1270) field 1273, and the taxes (first payment block 1270) field 1274. If the customer chooses not to execute the rental agreement until several days later, this field is recalculated to reflect the new dates (this will likely be done in the calculate payment due screen in the payments process).

The cash sale quote block 1280 is initially populated based on values in the working section block 1250, in addition to the values on the agreement/sale fees tab 1290.

The cash price field 1281 is the calculated cash price (no fees or taxes) for the selected items on the quote. It is a display-only field that is copied from the cash price (working section block 1250) field 1254, and is displayed to allow the user to easily see how the cash price, fees, and taxes combine to make up the total amount to purchase the items. If the cash price (working section block 1250) field 1254 is changed (either manually or automatically), the cash price field 1281 is automatically changed.

The fees field 1282 is the total fees for the cash sale quote 1280. The fees field 1282 is calculated by summing the amount column 1292 in the quote fees block 1291 for the fees that affect the cash sale, and cannot be modified by the user. To change the total fee amount on the quote, the user must change the amounts on the fee tab 1290.

The taxes field 1283 is the total taxes for the cash sale quote 1280. The field is set to zero if the customer is non-taxable. Otherwise, the taxes are calculated by adding the cash price field (cash sale quote 1280 block) and Fees (cash sale quote 1280 block), then multiplying the sum by the store's tax rate.

The cash amount field 1284 is the total expected payment amount if the user purchases the items outright. The cash amount is calculated by adding the cash price 1255 (working section block 1250), fees 1282 (cash sale quote 1280 block), and taxes 1283 (cash sale quote 1280 block).

The quote detail tab 1201 displays the various items that are being quoted. The user may select multiple items in a merchandise selection form to populate into the quote detail tab 1201 on the quote analysis form 1200. The user may then select (or deselect) the items to be used to create the quote, to change the quantity, to change the rental rates, or to change the cash sales price. The items described below are displayed in the quote detail block 1210 on the detail tab 1201.

The rental term field 1225 is based on the selection in the payment term (working section block 1250) field 1251. The rental term 1225 indicates how the amounts in the standard rate 1219, the proposed rate 1320, and the actual rate 1321 columns in the quote detail tab 1201 or block 1210 are applied. For example, if the rental term (quote detail tab 1201 or block 1210) field 1225 is displayed as weekly, the amounts in these 3 columns will be weekly amounts.

The select checkbox 1211 indicates the items that are currently being used to calculate the amounts in the other parts of the form. If an item is unchecked, it is not used in any calculations. In addition, if the quote is saved and the user leaves the form, any unchecked items are lost. If the user returns to a merchandise selection screen, selects more items, and then returns to the quote analysis form 1200, the newly selected items from the merchandise selection form have the select checkbox 1211 checked on this screen (along with any items that were already checked on the quote).

The product number 1212 is a product identifier for the item on the quote. The user may enter a product number 1212 in order to see the standard weekly, the standard monthly, and the standard cash price of the item. However, the item's specific serial number 1213 must be entered before the item can be added to a rental agreement. To enter a product number 1212, the user can enter a portion of the number and pull up a list of values (LOV) to display the product number 1212 and a description. The user can then select the desired product from the list.

The serial number 1213 is the product's serialized identifier. Before the quote can be processed to form a rental agreement, the serial number 1213 of each item must be entered. However, it is not required to have a serial number 1213 to save the quote. The user may enter the serial number 1213 directly into this field, and the application server automatically populates all the other fields of the line. When a serial number 1213 is entered, the application server checks to see if that item's status is “In Stock.” If the item is not in stock, an error message is displayed and the serial number 1213 field is cleared. In addition, the application server also checks to see if the serial number 1213 is saved on another valid quote. If so, the system displays an error message, and the serial number 1213 field is cleared.

The qty 1214 field is the quantity of each product number 1212 being quoted. If the user selects multiple product numbers 1212 on the merchandise selection form, but does not select specific serialized inventory, then the quantity from the merchandise selection form is used to populate this field. However, the user may also change the value in this field once the item has been pulled into the quote analysis form 1200. In addition, if the serial number 1213 field contains any value (whether valid or not), the qty 1214 field will automatically be set to 1.

The condition 1215 field is the condition 1215 of the item when it is initially added to the quote. For serialized merchandise, this field indicates the condition 1215 of the item listed on a serialized inventory table. For non-serialized merchandise, this field displays “special order” to indicate that the item may not necessarily be in inventory.

The Weeks left 1216 field indicates the amount of rental life still left on the item (in weeks). For new serialized items, or items where an “N” for new only is entered, this field displays the standard number of weeks for the item.

The proposed deposit 1217 is the amount of deposit suggested before an item may be rented.

The actual deposit 1218 is the amount of deposit that is actually required before an item may be rented. Initially, this field may be populated with the proposed amount calculated by the application server. However, the user has the ability to change this value manually, and any such changes are reflected in the deposit amount (working section block 1250) field 1256. In addition, if the user manually changes the value of the deposit amount (working section block 1250) field 1256, the individual actual deposit 1218 (quote detail tab 1201 or block 1210) fields for the selected items are recalculated proportionately.

The standard rental rate 1219 is the standard rental rate 1219 for new items with this product number 1212, and is based on the rental term 1225 (quote detail tab 1201 or block 1210) displayed. This field is not used in any calculations, and is provided to allow the user to compare the proposed rate (quote detail tab 1201 or block 1210) field 1320 with the actual rate (quote detail tab 1201 or block 1210) field 1321.

The proposed rental rate 1320 field is the system calculated rental rate for the item on the quote, based on the rental term (quote detail tab 1201 or block 1210) displayed and the periods (default terms block 1240) field calculated. For each item listed, the system computes the line item's agreement value (i.e., the item's weeks left 1216×the standard rental rate 1219). Then, this value is divided by the periods (working section block 1250) field 1253 value to get the item's proposed rate.

The actual rental rate 1321 field is the actual rental rate 1321 for the item on the quote, based on the rental term 1225 (quote detail tab 1201 or block 1210) displayed and the periods (default terms block 1240) field 1243 calculated. It is initially populated exactly the same as the proposed rate (quote detail tab 1201 or block 1210) field 1320. However, the user may manually enter a different value in this field. If the actual rate (quote detail tab 1201 or block 1210) field 1321 is changed on a selected item, the rental rate (working section block 1250) field 1254 is automatically updated. This update causes the system to attempt to correct the rental rate x periods =agreement value calculated, and a modal window (not shown) displays the following message: “The rental rate field was changed. Either the agreement value field or the periods field must be modified before the quote may be saved.” Below this message, three buttons are displayed: change agreement value, change periods, and cancel. If the change agreement value or change periods buttons are pressed, the appropriate field will be modified to make the equation balance (for agreement value changes, the rental rates in the quote detail block 1210 on the detail tab 1201 will also be adjusted). If the Cancel button is pressed, the system does not change anything.

The proposed cash price 1322 is the original cash price for the item that is currently stored in the system. For items where only a product number 1212 was entered, this is the standard cash price for that item. For serialized items, the original cash price is calculated as the standard cash price less the accumulated depreciation for the item (plus a rounding factor).

The actual cash price field 1323 indicates the cash price amount for which the customer can purchase the item outright. This value is initially populated with the value in the original cash price field, but may be overridden by the user. This amount is specific to the serialized item, and reflects any past rents paid by other customers for the item.

The product fees field 1324 shows any product-related fees applied to the line item (such as recycling fees for tires). This field is initially calculated by adding up the product-elated fees in the agreement/sale fees tab 1290. These fees are applied toward the rental agreement and/or cash sale, depending on the flags selected on the agreement/sale fees tab 1290. However, for each selected item, the user has the utility to override this calculated amount.

The agreement/sale fees tab 1290 displays the various fees attached to the rental quote 1260 or the cash sale quote 1280. The user may add the various fees by selecting them individually from a drop-down list. In addition, the user may indicate whether the fee is a recurring fee, a fee attached to a rental agreement, or a fee attached to a cash sale.

Any items not selected when the user saves the quote are deleted from the display. To add these items back in, the user has to type them in again, or re-select them through merchandise selection.

Other forms may be used to carry out the day-to-day business of the rent-a-tire store including the forms described above for the online POS management system, such as, for example, customer search, payments, inventory control, purchasing, merchandise selection, and time and attendance.

Other Features and Advantages

A number of advantages can be realized with a POS system according to the embodiments described herein. Since all forms displayed by the processing devices are standardized, employees can be easily trained to use the POS system. In addition, once trained, an employee can operate the POS system at any store without additional training. Furthermore, the forms present a limited number of options in the form or drop down menus, tabs, and buttons, which are easy for a new employee to operate. In addition, the drop down menus, tabs, and buttons offer limited, standardized data entries that reduce the chance of store employees erroneously inputting data in the forms.

The forms also are self-checking. After data has been entered into the forms and the data is submitted to the applications server, the forms are checked by the application server. Incorrect entries are flagged and returned to the user to correct. Help menus also may be provided to aid employees with proper data entry.

Further advantages include the following. All processing, storing, and retrieving is performed at one location, the home office. Information exchange is fast and secure through use of the Internet and the virtual private tunnel. In addition, each store has access to the current inventory of every other store. Furthermore, inexpensive computers can be used as user interfaces at each store. The computers can be easily replaced without having to copy or restore data conventionally stored in a store computer's memory. Time and effort associated with maintenance of the applications and database are also reduced significantly because all repairs are performed at the home office. Similarly, all updating of the applications or the database is performed at one location only.

A number of implementations have been described. Nevertheless, it will be understood that various modifications may be made without departing from the spirit and scope of the invention. For example, advantageous results still could be achieved if steps of the disclosed techniques were performed in a different order and/or if components in the disclosed systems were combined in a different manner and/or replaced or supplemented by other components. Accordingly, other embodiments are within the scope of the following claims.

What is claimed is:

1. A point-of-sale online store management system comprising:
a home office;
a store including a processing device having communications software for conducting a point-of-sale transaction;
a virtual private network connecting the home office and the store; and
a digital form sent from the home office through the virtual private network to the processing device,
wherein the digital form includes a data entry field to solicit data used to conduct the point-of-sale transaction and the digital form is processed by the home office to complete the point-of-sale transaction.

2. The point-of-sale online store management system of claim 1 wherein the home office includes an application server that generates the digital form and processes the solicited data according to a corresponding application to conduct the point-of-sale transaction.

3. The point-of-sale online store management system of claim 1 wherein the home office includes a router connected to the Internet and the store includes a router connected to the Internet, the routers forming the virtual private network between the home office and the store.

4. The point-of-sale online store management system of claim 1 wherein the home office is also a store.

5. The point-of-sale online store management system of claim 1 wherein the home office includes a database for storing the solicited data.

6. The point-of-sale online store management system of claim 2 wherein the home office includes a database and the application server retrieves information from the database when generating the digital form.

7. The point-of-sale online store management system of claim 2 wherein the communications software comprises a browser that displays the digital form sent from the application server.

8. The point-of-sale online store management system of claim 2 wherein the home office includes a database and the application server retrieves information from the database when processing the point-of-sale transaction.

9. The point-of-sale online store management system of claim 2 wherein the home office includes a database and the application server stores data derived from the processing of the solicited data.

10. The point-of-sale online store management system of claim 1 wherein the solicited data comprises customer information.

11. The point-of-sale online store management system of claim 1 wherein the solicited data comprises merchandise information.

12. The point-of-sale online store management system of claim 1 wherein the point-of-sale transaction comprises a rental agreement.

13. The point-of-sale online store management system of claim 1 wherein the home office and the store are connected through the Internet.

14. The point-of-sale online store management system of claim 1 wherein data sent between the home office and the store on the virtual private network is encrypted and authenticated to provide secure transactions.

15. A method for conducting a point-of-sale transaction between a home office and store comprising:
providing a virtual private network between the home office and the store;
transmitting a first interactive digital form from the home office to the store for display in the store;
displaying the first form in the store;
displaying a data entry field in the first form;
entering data in said data entry field;
sending the entered data to the home office;
processing the entered data;
transmitting a second interactive digital form from the home office to the store for display in the store in response to the entered data; and
completing a point-of-sales transaction at the store based on the second interactive digital form.

16. The method of claim 15 wherein providing the virtual private network includes connecting the store and home office to the Internet.

17. The method of claim 15 comprising interpreting the first and second digital forms using a browser at the store.

18. The method of claim 15 comprising processing the entered data using an application server in the home office.

19. The method of claim 15 comprising storing the entered data in a database at the home office.

20. A system for managing a store from a remote location comprising:
an application server located at the remote location;
a database connected to the application server;
a processing device located at the store; and
a virtual private network connecting the application server and the processing device, wherein
data stored in the database is processed by the application server to generate digital forms that are sent to the processing device to conduct point-of-sale transactions at the stores.

21. A point-of-sale online store management system including a home office and a store connected by the Internet comprising:
an application server located at the home office;
a processing device located at the store for conducting a point-of-sale transaction;
a virtual private network connecting the application server and the processing device;
a browser running on the processing device; and
a digital form sent from the application server over the virtual private network for interpretation and display by the browser, wherein
the digital form includes a data entry field to solicit data used to conduct the point-of-sale transaction and the solicited data is processed by the application server to complete the point-of-sale transaction.

22. The point-of-sale online store management system of claim 21 wherein the home office includes a router connected to the Internet and the store includes a router connected to the Internet, the routers forming the virtual private network between the applications server and the processing device.
